(19) United States
(12) Patent Application Publication
(10) Pub. No.: US 2025/0160328 A1
(43) Pub. Date: May 22, 2025

(54) COMPOSITIONS AND METHODS FOR REDUCING PARASITIC INFESTATION OF HONEY BEE HIVES

(71) Applicant: University of Georgia Research Foundation, Inc., Athens, GA (US)

(72) Inventor: Lewis Bartlett, Athens, GA (US)

(21) Appl. No.: 18/859,097

(22) PCT Filed: Apr. 24, 2023
(86) PCT No.: PCT/US2023/019597

§ 371 Date: Oct. 22, 2024

Related U.S. Application Data
(60) Provisional application No. 63/333,877, filed on Apr. 22, 2022.

(51) Int. Cl. A01N 43/56; A01N 25/00; A01P 7/04

(52) U.S. Cl. CPC A01N 43/56; A01N 25/006; A01P 7/04

(57) ABSTRACT

Compositions suitable for administration to or ingestion by honey bees and colonies thereof comprising an effective amount of an anthranilic diamide insecticide to reduce or prevent a parasitic insect infestation of the honey bees' hive are provided. In some embodiments, the composition is non-toxic and optionally, but preferably nutritional to the bees. In some embodiments, the composition further includes a source of carbohydrates, proteins, lipids, vitamins, minerals, water, or a combination thereof. Such sources can be, for example, natural or artificial nectar, honey, sugar, sugar syrup, pollen or pollen substitute, soy flour, soy meal, gluten, skim milk, yeast, pollard, oil, or combinations thereof. Preferred anthranilic diamides are chlorantraniliprole and flubendiamide, preferably wherein the amount of the anthranilic diamide is below the contact and/or oral LD50 for the bee. Devices for delivering the compositions and method of use thereof are also provided.

### CROSS-REFERENCE TO RELATED APPLICATIONS

This application claims the benefit of and priority to U.S. Ser. No. 63/333,877 filed Apr. 22, 2022, and which is incorporated by reference herein in its entirety.

### FIELD OF THE INVENTION

The invention is generally related to honey bees, and more particularly to compositions and methods for prophylactically and/or therapeutically protecting their colonies from infestation of small hive beetles and other arthropod parasites.

### BACKGROUND OF THE INVENTION

Small hive beetles, Aethina tumida, are a prominent honey bee pest across much of the United States. A. tumida are an established destructive pest in the Southeast of the U.S., and frequently kill colonies if placed in shade or following tropical storms. While conventional mechanical and biocontrol techniques to control A. tumida are used by beekeepers, these efforts have failed to fully control this burdensome honey bee pest.

A consequence of A. tumida's parasitism is a widespread reluctance among beekeepers in the Southeast to undertake supplementary protein (pollen or pollen substitute) feeding as part of routine colony management. Although feeding of sugar solutions is a common practice to aid in colony provision, pollen supplementation is rare in parts of the USA due to risks of severe A. tumida infestation. This is despite widespread evidence that protein provision, such as polyfloral pollen, is an important component of honey bee health, for instance in reducing infectious pathogen burdens (Alaux et al., Biol. Lett. 6:562-565 (2010)) including of viruses (Dolezal et al., R. Soc. Open Sci. 6:181803 (2019)) which are a pernicious contributor to honey bee decline. Therefore, there is need for additional means for treating or preventing A. tumida infestation.

Thus, it is an object of the invention to provide compositions and methods of treating and preventing A. tumida infestation, particularly in honey bee hives.

### SUMMARY OF THE INVENTION

Compositions suitable for administration to or ingestion by a honey bee colony comprising an effective amount of an anthranilic diamide insecticide to reduce or prevent a parasitic insect infestation of the honey bees' hive are provided. In some embodiments, the composition is non-toxic and optionally, but preferably nutritional to the bee. In some embodiments, the composition further includes a source of carbohydrates, proteins, lipids, vitamins, minerals, water, or a combination thereof. Such sources can be, for example, natural or artificial nectar, honey, sugar, sugar syrup, pollen or pollen substitute, soy flour, soy meal, gluten, skim milk, yeast, pollard, oil, or combinations thereof. In some embodiments, the source is a commercial bee feed or supplement such as AP23®, BEE-PRO®, FEEDBEE, MEGABEE, ULTRA BEE, HIVE ALIVE, or SUPERDFM®-HONEYBEE™.

Preferred anthranilic diamides are chlorantraniliprole and flubendiamide, preferably wherein the amount of the anthranilic diamide is below the contact and/or oral LD50 for the bee, more preferably wherein the dosage does not raise the mortality of the honey bees. In some embodiments, the amount of the anthranilic diamide is about 0.01 μg/bee to 100 μg/bee, or about 0.1 μg/gram to 100 μg/gram, or any subrange or specific dosage therebetween.

The composition can be a liquid, or a solid such as a powder, patty, or candy.

In some embodiments, the composition includes a further therapeutic active agent, such a pesticide, for treating another disease or condition of the bees or their hive, such as varroa.

Honey bees include Apis andreniformis (the black dwarf honey bee); Apis cerana (the eastern honey bee); Apis dorsata (the giant honey bee); Apis florea (the red dwarf honey bee); Apis koschevnikovi (Koschevnikov's honey bee); Apis laboriosa (the Himalayan giant honey bee); Apis mellifera (the western honey bee); and Apis nigrocincta (the Philippine honey bee). In some embodiments, the honey bee is a domesticated honey bee such as Apis mellifera or Apis cerana. Parasitic pests include the small hive beetle (Aethina tumida) and wax moth (Achroia grisella).

In preferred embodiments, the composition is both nutritional and/or therapeutic for the honey bee and also a lethal attractant to the pest.

Devices including the disclosed compositions are also provided. Devices include, for example, strips which may have one, two, or more than two layers. In some embodiments, the device includes a carrier optionally selected from a polymeric or starch or sugar-based material. In some embodiments, the anthranilic diamide is released as it is exposed, optionally due to the carrier breaking down, optionally by being eaten or disassembled by bees or pests, disintegrating, dissolving, decomposing, or otherwise degrading.

Methods of treating or preventing parasitic pest infestation of a bee colony or hive thereof are also provided. Such methods typically include placing a disclosed composition or device in, on, or adjacent to a bee hive. The hive can be, and preferably is, occupied by a colony of bees. The composition or device can be replaced periodically, for example, every 0.5, 1, 2, 3, 4, 5, 6, 7, 8, 9, 10, 11, 12, 12, 14, 15, or more days or months.

Also provided are stock insecticide compositions for preparing a composition suitable for administration to or ingestion by a honey bee. The stock composition can, for example, honey bee-safe, shelf-stable concentrate suitable for direct incorporation as a feed additive into honey bee feed. The stock can be, for example, a 2×-20× stock of insecticide relative to the diluted composition. Preferably, the stock is a liquid stock. In some embodiments, the stock includes 0.2 μg/ml to 2 mg/ml of an anthranilic diamide insecticide such chlorantraniliprole or flubendiamide. The stock can include a solvent and optionally a stabilizing solution. In some embodiments, the solvent is an organic solvent optionally selected from methanol, acetone, ethanol, and ethyl acetate. In preferred embodiments, the stabilizing solution is glycerol. An exemplary preferred ratio of insecticide:liquid is 1:1.

Methods of making a composition suitable for administration to or ingestion by a honey bee are also provided. The methods can include diluting a liquid stock composition, e.g., 2×-20×, with a source of carbohydrates, proteins, lipids, vitamins, minerals, water, or a combination thereof. In some embodiments, the source includes natural or artificial nectar, honey, sugar, sugar syrup, pollen or pollen substitute, soy flour, soy meal, gluten, skim milk, yeast, pollard, oil, or combinations thereof. Exemplary sources include, but are not limited to, AP23®, BEE-PRO®, FEEDBEE, MEGABEE, ULTRA BEE, HIVE ALIVE, or SUPERDFM®-HONEYBEE™. In some embodiments, the source is a solid source and the final concentration range of the insecticide is 0.01 μg/gram to 100 μg/gram insecticide/solid source or any subrange or specific dosage therebetween. In some embodiments, the source is a liquid source and the final concentration range of the insecticide is 0.1 μg/ml to 100 μg/ml insecticide/liquid source, or any subrange or specific dosage therebetween.

In some embodiments, the liquid stock insecticide includes instructions for diluting the stock insecticide compositions and how to use the honey bee-safe composition for reducing or preventing a parasitic insect infestation of the honey bee's hive.

### BRIEF DESCRIPTION OF THE DRAWINGS

FIG. 1 are annotated images from an experiment testing the impact of chlorantraniliprole on small hive beetle (SHB). Upon retrieval, 9/10 control pots showed immediately visible infestation rates. Following two weeks of incubation to hatch eggs, 10/10 product-treated supplementary food remained SHB-infestation free, while 10/10 control/untreated feed showed very extensive infestation with many hundreds of parasitic SHB larvae. The images show SHB larvae positive pots (“O”) and SHB larvae negative pots (“X”). Pots treated with chlorantraniliprole are displayed on the left half of the graph, control pots on the right half.

FIG. 2 is a bar graph of the experimental results from FIG. 1, showing the infestation rates of protein substitute mixed with concentrated solution of chlorantraniliprole, methanol, and glycerol according to trial instructions compared to untreated/control supplementary feed. Instructions achieved approximately 10 μg chlorantraniliprole per 1 g protein feed. Briefly, chlorantraniliprole was dissolved in methanol at a ratio of 1 mg chlorantraniliprole to 1 ml methanol via agitation/stirring. Chlorantraniliprole-methanol solution was cooled to −20° C. and then suspended/mixed into glycerol also cooled to −20° C. and stored between 4° C. and −20° C. to create a shelf-stable product. Product was then mixed into lethal attractant/supplementary feed at a rate of 50 ml formulated product per 1 kg feed or attractant via either mechanical or hand mixing at ambient temperature (200 ml of 80% glycerol/20% methanol was added to 4 kg of protein feed (i.e., 40 ml glycerol and 10 ml methanol per 1 kg protein feed). Treated attractant/feed mixture was then ready for deployment in the honey colony.

FIG. 3 is an image of a chlorantraniliprole-treated patty prior to recovering it after short placement in a honey bee colony during field testing. It was placed on top of wax paper to keep it ‘whole’. The image was taken during a colony inspection when the bee hive was open. The image shows that only a small amount of the original full-sized ‘patty’ remains.

FIG. 4 is a mortality curve of honeybees (lower line) and small hive beetles (upper line) at different dosages of chlorantraniliprole (μg/gram feed).

### DETAILED DESCRIPTION OF THE INVENTION

### I. Definitions

As used herein “honey bee” and “honeybee” and “bee” are used interchangeably and refer to members of the genus, Apis. While about 20,000 species of bees exist, only eight species of honey bee are recognized, with a total of 43 subspecies, although historically seven to 11 species are recognized: Apis andreniformis (the black dwarf honey bee); Apis cerana (the eastern honey bee); Apis dorsata (the giant honey bee); Apis florea (the red dwarf honey bee); Apis koschevnikovi (Koschevnikov's honey bee); Apis laboriosa (the Himalayan giant honey bee); Apis mellifera (the western honey bee); and Apis nigrocincta (the Philippine honey bee). Domesticated honey bees include Apis mellifera and Apis cerana.

As used herein, “hive” refers to a place wherein bees live. A hive can be natural or artificial, and includes, but it not necessarily limited to nests which can be natural or artificial cavities that can be hanging and exposed, as well as artificial/man-made structures to house a honey bee nest. A hive or collection of hives can form part or all of a farm or apiary. A hive may or may not contain bees at any given time.

As used herein, “colony” refers to a family unit of bees including a queen and workers with or without drones. A colony can be physically present in a hive.

As used herein, “effective amount” means that the amount of the composition used is of sufficient quantity/concentration to affect an intended response. The precise dosage can vary according to a variety of factors such as species, subject-dependent variables (e.g., organism size, age, immune system health, etc.), the compound(s) being used, as well as the route of administration and the pharmacokinetics and pharmacodynamics of the agent being administered.

As used herein, the term “reduce” means to decrease an activity, function, response, condition, disease, or other biological parameter. This can include, but is not limited to, the complete ablation of the activity, function, response, condition, or disease.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied.

Disclosed are materials, compositions, and components that can be used for, can be used in conjunction with, can be used in preparation for, or are products of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein. For example, if a ligand is disclosed and discussed and a number of modifications that can be made to a number of molecules including the ligand are discussed, each and every combination and permutation of ligand and the modifications that are possible are specifically contemplated unless specifically indicated to the contrary. Thus, if a class of molecules A, B, and C are disclosed as well as a class of molecules D, E, and F and an example of a combination molecule, A-D is disclosed, then even if each is not individually recited, each is individually and collectively contemplated. Thus, in this example, each of the combinations A-E, A-F, B-D, B-E, B-F, C-D, C-E, and C-F are specifically contemplated and should be considered disclosed from disclosure of A, B, and C; D, E, and F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and C; D, E, and F; and the example combination A-D. Further, each of the materials, compositions, components, etc. contemplated and disclosed as above can also be specifically and independently included or excluded from any group, subgroup, list, set, etc. of such materials.

These concepts apply to all aspects of this application including, but not limited to, steps in methods of making and using the disclosed compositions. Thus, if there are a variety of additional steps that can be performed it is understood that each of these additional steps can be performed with any specific embodiment or combination of embodiments of the disclosed methods, and that each such combination is specifically contemplated and should be considered disclosed.

All methods described herein can be performed in any suitable order unless otherwise indicated or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

### II. Compositions

It has been discovered that insecticides of the anthranilic diamide class can control Aethina tumida and allow beekeepers to safely pursue nutritional supplemental bee feeding (e.g., supplementary protein including but not limited to pollen) without the risk of severe A. tumida infestation. The routine supplementation of (e.g., protein) permitted by this intervention can also improve holistic bee health.

Thus, compositions including an effective amount of an anthranilic diamide class insecticide and methods of use thereof for controlling infestation of honey bee hives by parasitic pests such small hive beetles (Aethina tumida) and wax moths (Achroia grisella) are provided.

### A. Insecticides

The disclosed compositions typically include an effective amount of an anthranilic diamide class insecticide. Anthranilic diamide insecticides potently activate the insect ryanodine receptor relative to its mammalian counterpart, releasing stored calcium from the sarcoendoplasmic reticulum and causing impaired regulation of muscle contraction (Cordova, et al., Pesticide Biochemistry and Physiology, 84(3):196-214 (2006)). This leads to impaired regulation of insect muscle contraction causing rapid paralysis and eventual death.

Typically, the anthranilic diamide insecticide of the disclosed compositions and methods is one for which a target pest is more sensitive than honey bees and/or used in an amount and/or administered in a means that disproportionately impacts the pest relative to honey bees. As used herein, the pest (also referred to herein as a parasite) typically refers to the small hive beetle (Aethina tumida) (SHB) and other arthropods that infest honey bee hives such as wax moths (Achroia grisella).

Preferably, the anthranilic diamide insecticide kills or prevents the pest's (e.g., A. tumida) growth and/or reproduction. The anthranilic diamide class insecticide also typically has little or no toxicity to honey bees. In some embodiments, little or no toxicity means that honey bees that consume and/or are otherwise exposed to the anthranilic diamide class insecticide do not experience impaired regulation of muscle contraction and/or rapid paralysis and eventual death, or experience these effects at a reduced degree relative to a pest such as A. tumida e.g., 50, 40, 30, 25, 20, 15, 10, 5, or less than 5 percent relative to a pest such as A. tumida. As illustrated in the experiments below, a dosage well below the lethal dose for honey bees, e.g., the dose that results in 50% mortality to honey bees in the test population (also known as the LD50), is effective to reduce or eliminate pest infestation, and elevated mortality of honey bees was not detected in the tested dosage range. Thus, the dosage is typically at or below the LD50, and is preferably used in a dosage at or below the dose that results in significantly elevated honey bee mortality compared to a test populations e.g., of target pests such as SHB and wax moths.

Examples of anthranilic diamide insecticides that have demonstrated little or no intoxication symptoms to honey bees under certain test conditions include, for example, chlorantraniliprole and flubendiamide. See, e.g., “Pesticides & Bee Toxicity,” Minnesota Department of Agriculture website, mda.state.mn.us/protecting/bmps/pollinators/beetoxicity. Thus, in some embodiments, the anthranilic diamide is chlorantraniliprole or flubendiamide.

In preferred embodiments, the anthranilic diamide is chlorantraniliprole. As with other anthranilic diamides, chlorantranilipole has a specific mode of action: it stimulates ryanodine receptors causing calcium store release in insect muscle and lethal paralysis. It is hypothesized that molecular differences in the sarcoplasmic reticulum calcium-release pathway between the hymenoptera and the coleoptera lead to its atoxicity in hymenoptera. Chlorantraniliprole has no detectable negative effects on bumblebee colony growth or mortality, and EPA registration documentation for chlorantraniliprole as a lawn-treatment shows extremely low toxicity to Apis mellifera (EPA 2008)—with an LD50 in excess of >0.1 mg/bee, more than 2000× less toxic than a comparable neonicotinoid, clothianidin. In another report, chlorantraniliprole has a reported oral LD50 in honey bees of 114.1 (μg/bee) and 1,141,000 (ppb) (Larson et al., PLOS ONE 8:e66375 (2013), Larson, et al., Ecotoxicology, 23:252-259 (2014), and experiments below). See also Abbassy, et al., Austin Environ Sci., 5(2):1046 (2020), 6 pages; and Kadala, et al., Sci Rep 9, 2153 (2019), 9 pages, doi.org/10.1038/s41598-019-39193-3).

While Larson et al., Pest Manag. Sci. 68:740-748 (2012) found no evidence of apparent in-field toxicity of chlorantraniliprole to adult carabid beetles, initial phylogenetic comparison and consultation with a coleopterist shows that A. tumida—a nitidulid—is much more closely related to and more likely to share vulnerability with the scarabid beetles for which chlorantraniliprole has established efficacy (McKenna et al., Proc. Natl. Acad. Sci. 116:24729-24737 (2019)).

In some embodiments, the disclosed compositions and methods utilize a commercial formulation of chlorantraniliprole. Such products include, but are not limited to, Coragen® (Dupont), Acelepryn™ (Dupont), Rynaxypyr® (Dupont), Besiege® (Syngenta), Altacor® (FMC), and Prevathon® (Dupont). Other formulations are discussed in, for example, U.S. Published Application Nos. 2014/0296298, 2015/0173350, 2016/0205940, 2017/0215419, 2021/0112810, and Published PCT Application No. WO 2004/027042, each of which is specifically incorporated by reference herein in its entirety.

In some embodiments, the insecticide is flubendiamide. Flubendiamide is also reported to have low toxicity to honey bees, having a contact and oral LD50 of 200 μg/bee and 2,000,000 (or 200,000) ppb.

In some embodiments, the disclosed compositions and methods utilize a commercial formulation of flubendiamide. Such products include, but are not limited to, Belt® (Bayer CropScience), Vigilante® (Chemtura Corp.), and Tourismo® (Nichino America, Inc).

The experimental results presented below show that chlorantraniliprole is effective as a pesticide to control Aethina tumida but with low toxicity to Apis mellifera. Furthermore, Apis mellifera willingly and safely consumed pollen dosed with chlorantraniliprole under supplementary feeding conditions in the field, and such pollen did not become infested with Aethina tumida.

### B. Insecticide Compositions and Formulations

Disclosed are compositions that can be modified to include an effective amount of an anthranilic diamide insecticide such as chlorantraniliprole or flubendiamide. Such compositions can be used to prepare and/or deliver the insecticide to the bee hive and/or colony for the purpose of controlling pests such as A. tumida, preferably with little or no harm to honey bees.

In some embodiments, the insecticide is formulated in a liquid. The liquid can be a concentrated form used for storage and/or addition to a second composition such as a bee food or supplement. In some embodiments, the liquid formulation is a final composition for delivery directly to the hive or colony. Such liquids can include, for example, a solvent that poses little or no toxicity to honey bees. Such solvents include, but are not limited to, methanol, acetone, ethanol, ethyl acetate, or other organic solvents. In a particularly preferred embodiment, the solvent is methanol.

In some embodiments, the liquid composition includes a stabilizing solution. Such solutions include, but are not limited to, glycerol, vegetable oil, mineral oil, or high viscosity mono-, di-, or oligo-saccharide solutions.

In some embodiments, the composition is a solid such as a powder, patty, or candy. Some advantages of such solid products compared to their liquid equivalents can include durability; greater ease and economy of transport; greater ease of administration, avoids the need for water or other liquids, such as sugar molasses or syrups; less time and lower labor costs to distribute the product in the hive, as it is a ready-made product and does not require dilution operations with control of the water percentages in solution, weighing, or problems of finding a source of water; greater durability of the product inside the apiary; possibility for bees and/or pests to consume the product in a selective manner: in fact, in the liquid form the key ingredients are completely solubilized and cannot be separated, while the granular/powder form gives the bees the opportunity to consume the product according to the needs of the season and according to specific needs; greater flexibility and control of the substances and ingredients to be assumed by the bees of the three castes (workers, drones, queen) through the average size of the granules of the powdered product (particle size), which can range from, e.g., 10 to 1000 μm (similar to the average size of pollen in nature). Under 10 μm size powder products have shown drawbacks such as compaction, and in general it is more prone to absorption of moisture and tither liquid products present in the beehive, with acceleration of the degradation of the product quality. For particle sizes exceeding 1000 μm there may be problems in the homogenization of the basic ingredients of the formulation, with concentration gradients not uniformly distributed; also, a greater difficulty for bees in eating the product due to the weight of the single granule is possible, as well as a difficulty in handling the granule itself during consumption. These forms can be particularly advantageous when the insecticide is introduced to the hive or colony using a bee supplement carrier.

A challenge to bee survival is overcoming inadequate nutrition. The chief source of protein for most bees is pollen, and insufficient supplies of pollen often lead to diminished bee survival and reduced reproduction rates, causing bee colony size to rapidly diminish. A common solution implemented by beekeepers to counteract this problem is to provide bees with a protein supplement; however, beekeepers are often reluctant to utilize protein supplements due to their tendency to attract small hive beetles (SHB) and wax moths. The pests do not parasite individual bees, but rather parasite the honey bee hive by eating through food stores and predating larval bees. This ‘food stealing’ means beekeepers can not feed their bees certain food supplements (including protein supplements such as supplementary pollen/pollen substitute) as the food quickly becomes infested with the parasitic pests, leading to the colony being overwhelmed/killed. This is despite widespread evidence that protein/pollen is an important component of honey bee health, for instance in reducing infectious pathogen burdens, including viruses, which are a contributor to honey bee decline. By providing a substrate for the pests to lay eggs and develop, the supplements may foster infestation and colonization. Bees typically consume much less, if any, of an infested feed composition, resulting in wasted feed, increased pest loads, decreased bee nutrition, potentially leading to bee death, and large monetary losses.

The disclosed compositions and methods thus directly address this paradox. The disclosed formulations provide for routine supplementation of protein and improve bee health, while also reducing or eliminating the pests.

Thus, the disclosed anthranilic diamide insecticide such as chlorantraniliprole and flubendiamide can be used separately (e.g., separate compositions) or together (e.g., the same admixture) with other bee heath and nutritional compositions. For example, in some embodiments, the anthranilic diamide insecticide such as chlorantraniliprole or flubendiamide is combined with a protein supplement such as, but not limited to, pollen, or simple or complex mixture of nutritional, prophylactic, and/or therapeutic agents. In some embodiments, the disclosed composition including e.g., nutritional supplements simultaneously address food shortages while minimizing or eliminating a more undesired consequence of food supplementation (e.g., SHB or wax moth infestation).

Thus, in some embodiments, such insecticide compositions further include additional ingredients, which may have nutritional and/or further prophylaxis value to the bees.

For example, in some embodiments, the composition, i.e., in liquid or solid, e.g., a powder or in patties, for use as nourishment for bees and for the prophylaxis and treatment of parasitic pests such as A. tumida, includes an effective amount of an anthranilic diamide insecticide such as chlorantraniliprole or flubendiamide and one or more of the following substances, each of which is discussed in more detail below:
a) tonic and/or nutritious ingredients, e.g., algae containing vegetal proteins, alone or in combination with yeasts; sugars and lower organic acids;
b) natural antioxidants and/or antiseptics such as those contained in the essential extracts of Origanum vulgare and Pelargonium graveolens or geranium essential oil, and in the essential extract of one or more other aromatic or medicinal plants selected from Crocus sativus, Monarda citriodora, Melissa officinalis, Myristica fragrans and Origanum majorana; and/or
c) curative substances for bees, such as thymol and essential extract of Thymus vulgaris, oxalic acid, extracts of Aloe vera or Aloe arborescens, geraniol and extracts of Beta vulgaris cv. Altissima and mixtures of two or more of the same.

Examples of substances that can be used in the preparation of liquids and solids including powders, candies, and paddies include, but are not limited to:

### 1. Nutrient and Tonic Substances

Yeasts, of which the bees are very fond, as for example brewer's yeast, which is very rich in vitamins B, are preferably added to amino acids such as those of vegetable origin contained in algae. In some embodiments, the algae is spirulina (Arthrospira platensis), kelp (Laminariales), Klamath (Aphanizomenon flos-aquae) or chlorella (Chlorella vulgaris). The protein content of these algae is about 50%, with a fat content of about 7%.

A proper blending of protein sources is preferred to ensure the appropriate percentages of amino acids that are important for the development of larvae and adult individuals. In addition to being important for their amino acid contribution, algae are used for their supply of micronutrients, minerals (e.g., up to 1.5% in dry weight of the algae), iron and other metals and vitamins (up to 2% by dry weight of the algae).

In particular, it has been noted that the addition of proteins of vegetal origin such as algae and brewer's yeast instead of animal proteins in the formulation results in a triple advantage: a) a component (i.e. milk) is eliminated which, due to the content of caseins, is subject to rancidity; b) the protein content contained in the feed significantly increased; c) the palatability of the product for bees is improved, as the bees consume the product better than the corresponding product with animal proteins. In addition, a possible toxicity to bees due to the use of an animal source of proteins is eliminated, and a product having an amino acid pattern similar to that of royal jelly and of pollen is obtained in terms of percentages and types of amino acids present. Moreover, a formula is obtained which can be used in powder form for the preparation of patties or cake.

To increase the palatability of the protein feed to be administered, sugars e.g., of the glucose, dextrose, sucrose, or fructose type can be added. Examples of suitable sugars include, for example, honey, corn syrup, and mixtures of mono-, di-, and oligo-saccharides. For example, in some embodiments, a protein supplement such as pollen and/or icing sugar (e.g., sucrose) is added in an amount ranging from 5% to 15% on the total dry weight of the formulation. As nutrients, vitamin E and essential amino acids extracted from Aloe arborescens or Aloe vera have also been used, which are listed below among the substances having curative activity.

Acetic acid and/or lower carboxylic or dicarboxylic acids C₂-C₆. Acetic acid, tartaric acid and citric acid have the ability to cleave the molecules of sucrose, promoting assimilation by the bees. Also, such acids are antifungals useful in combating the presence of the fungus Nosema and other fungal forms. Specifically, in some embodiments, the formulation contains acetic acid at a maximum concentration of 6% by weight, that helps to have a product pH below 7. A source of ascorbic acid (vitamin C), such as, for example, lemon juice (which contains the same, in addition to the most abundant citric acid), may be included in the formulation as a vitamin compound, as well as an anti-oxidant.

Sources of fatty acids: lecithin, or a mixture of oils or a mixture of oils and lecithin, as a source of short, medium and long chain fatty acids may be added. For example, ricinoleic, tricosanoic, myristic, myristoleic, linoleic, palmitic, palmitoleic, lauric acids, in which the correct ratio of omega 6 to omega 3 fatty acids must be set to at from 0.01% to 3%.

Sources of sterols: for example, a combination of 24 methylene cholesterol, campesterol, beta-sitosterol, cholesterol (0.01% to 4%), canola oil derivatives, borage oil (Borago officinalis), Echinum spp. oil, turnip seed oil derivatives may be used.

Essential oils, or their components, can be added and may increase the palatability of the product. Examples include, but are not limited to, hydroxycinnamic acid, quercetin, rutin, narigenin, p-coumaric acid, contained in the essential oil of lemon balm and in the essential oil of monarda.

Some embodiments include attractant substances for bees, such as essential extract of Cymbopogon citratus, Citrus spp., honey, or other plant volatiles known to encourage feeding behavior in bees.

Some embodiments include probiotics, e.g., containing an effective amount of microbes to improve bee health. In some embodiments, the probiotics include one or move dried or live bacterial and/or fungal cultures.

In the case of use as a candy products/patties: stabilizers for patties, such as emulsifiers, lecithin and vegetable oils (coconut oil and others) can be added.

As introduced above, a common protein source is yeast, e.g., brewer's yeast, baker's yeast, grain distillers dried yeast, and/or torula yeast, but other sources include, for example, corn gluten meal, soy or soy products, and/or egg powder. As introduced above, a common fat source is oil, e.g., vegetable oils, encapsulated essential oils, medium chain fatty acids, sterols, and/or propionic acid. As introduced above, minerals, amino acids and/or micronutrients can also be included, such as iron, choline chloride, copper, copper sulfate, zinc, zinc sulfate, potassium, potassium chloride, potassium sorbate, chromium, aluminum, phosphorus, manganese, manganese sulfate, magnesium, magnesium sulfate, calcium, calcium sulfate, calcium iodate, calcium pantothenate, calcium propionate, sodium, sodium molybdate, isoleucine salt, cadmium, selenium, sulfur, nickel, L-tryptophan, and/or lead. As introduced above, vitamins and vitamin sources can also be included, such as vitamin A, vitamin K, riboflavin, pyridoxine, pyridoxine hydrochloride, thiamine, thiamine mononitrate, citric acid, nicotinic acid, vitamin A acetate, vitamin E supplement, vitamin B12 supplement, cholecalciferol, menadione sodium bisulfite complex, pantothenic acid, inositol, folic acid, biotin, L-ascorbyl-2-polyphosphate, P-aminobenzoic acid, and/or gibberellin acid. As introduced above, carbohydrates can be included such as sugar-based carbohydrates. Liquid sugar-based carbohydrates can be high in sucrose and may include, for example, honey, syrup, corn syrup, sugar syrup, liquid sucrose, fructose, and/or molasses. Additional or alternative carbohydrate sources include various types of flour, e.g., canola flour, sunflower flour, sorghum flour, wheat flour, and/or triticale flour.

In some embodiments, the composition includes blood meal, e.g., from blood captured as a byproduct of processing various animals, e.g., livestock or poultry. The blood may then be dried to form a powder, e.g., spray dried blood. In some implementations, the blood meal may be spray dried. The blood meal may have a moisture content of about 3 wt %. The blood meal may include one or more of the 10 amino acids essential to the honey bee diet, including but not limited to: methionine, tryptophan, arginine, lysine, histidine, phenylalanine, isoleucine, threonine, leucine and valine. See, e.g., U.S. Patent Application No. 2019/0098916.

In some embodiments, the composition includes seaweed or seaweed extract.

### 2. Antioxidants and Antiseptics

Essential oils with a high content of antioxidants and/or antiseptics can be added to the formulation, for example, carotenoids of the type of crocetin, crocin and picrocrocin extracted from flowers and/or stigmas of saffron (extracts of Crocus sativus); essential oils as limonene, e.g. extracted from lemon; geraniol, citronellol, terpineol and linalool, extracted from Pelargonium graveolens (geranium), or from Monarda citriodora var. citriodora; myristicin, elemicin, geraniol and/or safrole and other aromatic ethers extracted from Myristica fragrans (nutmeg); carvacrol, thymol and other minor phenols extracted from Origanum vulgare (ssp hirtum); and terpenes such as terpineol, borneol, sabinene and linalool, extracted from Origanum majorana.

Such active ingredients can be extracted, for example, from the plant species mentioned above and usually have a purity exceeding 55%, or they can be made synthetically.

Another advantageous antioxidant of vegetable origin can be obtained from the dried roots of a plant of the polygonaceae, Polygonum cuspidatum, from which a 98% resveratrol extract can be obtained. This powerful antioxidant is also present in other plants belonging to the genera Polygonaceae and Vitaceae.

### 3. Other Therapeutic Substances

In some embodiments, other therapeutic substances are added. Such additional therapeutic substances can, for example, counteract and/or prevent mites, as well as harmful fungal forms, viruses and the undesired side effects of other pesticides such as neonicotinoids, there were used, in alternative to thymol produced by synthesis, the biologically active substances contained in the essential oil of Thymus vulgaris (common thyme) of the types red thyme essential oil (or oil of first distillation) and white thyme essential oil (or oil of second distillation). Thyme, whose essential oil is widely used in beekeeping, contains the two phenolic compounds with biocidal activity thymol (very active against Varroa) and carvacrol, as well as cineol, borneol, menthone, pinene, geraniol, alpha-terpineol and other terpene compounds.

In addition, substances contained in the essential oil of Aloe vera, or in the essential oil of Aloe arborescens (a species of less widespread aloe but richer in active biological ingredients) can be used. Aloe vera contains, similarly to Aloe arborescens, many biologically active compounds, including acemannan (a mucopolysaccharide known for its immunomodulatory activity, with antiviral action), cinnamic acid (germicidal, fungicide, analgesic), crysophanic acid (antimycotic), anthraquinones, including aloin (bactericide) and emodin (antiviral); beta-sitosterol, in addition to salicylic acid (anti-inflammatory) isobarbaloin (analgesic), socaloin, capaloin and barbaloin (anti-bacterial). It should be noted that the extracts of this plant also contain all essential amino acids and vitamin E.

A good efficacy has been found in the use of extracts of the common beet or Beta vulgaris cv. altissima (sugar beet), which contains betalains (red pigments, attractants for bees), flavonoids, trimethylglycine (betaine), compounds with antioxidant activity, oxalic acid and vitamins belonging to group B.

Other medicinal substances can be added by adding geranium essential oil, which is extracted from geranium (Pelargonium) flowers and leaves and has geraniol as its main component, which is a terpene alcohol active as an antiseptic or antibacterial, as well as borneol, citronellol, linalool, terpineol, limonene, pinene and α-methyl-eugenol, all of which are active antioxidants. Alternatively, only the chemical compound geraniol can be used.

Further, oxalic acid can be added, e.g., in amounts not higher than 0.1% of the total formulation to increase the disinfectant effect.

Extracts (for example, alcoholic extracts) of fungal mycelium may be added, e.g. from fungi belonging to the phylum of the Basidiomycetes (Basidiomycota), order Polyporales, which have been shown to have antiviral properties against several viruses associated with the presence of varroa in the hive. Exemplary species include Fomes fomentarius, Ganoderma applanatum, Ganoderma resinaceum and Trametes versicolor, with final proportions e.g., from 0.01% to 1% by weight.

American foulbrood is caused by the rod-shaped, spore-forming bacteria, Paenibacillus larvae, P larvae infection is the most widespread and destructive of the bee brood diseases. Bee larvae up to 3 days old become infected by ingesting spores that are present in their food. Young larvae less than 24 hours old are most susceptible to infection. Spores germinate in the gut of the larva and the vegetative form of the bacteria begins to grow, taking its nourishment from the larva. Spores will not germinate in larvae over 3 days old. Infected larvae normally die after their cell is sealed. The vegetative form of the bacterium will die but not before it produces many millions of spores. Each dead larva may contain as many as 100 million spores. This disease only affects the bee larvae but is highly infectious and deadly to bee brood, infected larvae darken and die.

Various antibiotics and antimicrobial products are available for treating American foulbrood and/or European foulbrood (Melissococcus plutonius). Antibiotics, in non-resistant strains of the pathogen, can prevent the vegetative state of the bacterium forming. Drug treatment to prevent foulbrood spores from successfully germinating and proliferating is possible using, e.g., oxytetracycline hydrochloride (Terramycin) and tylosin tartrate. Unfortunately, such broad spectrum antibiotics kill beneficial bacteria as well as P. larvae. Moreover, the pathogenic bacterial can build a tolerance to such antibiotics.

Products that can improve the health of bees and may be effective for treating foulbrood include SUPER BEE DFM, a probiotic formulation that contains a variety of mixed fungus and bacteria, which are designed to compete with pathogenic strains, like P. larvae. HIVE ALIVE is another probiotic formulation that contains bacteria, which will compete with infectious strains. More particularly, SUPER BEE DFM includes dried Lactobacillus acidophilus fermentation product, dried Enterococcus faecium fermentation product, dried Bifidobacterium bifidum fermentation product, dried Lactobacillus plantarum fermentation product, dried Saccharomyces cerevisiae fermentation product, dried Bacillus subtillis fermentation product, dried Bacillus licheniformis fermentation product, dried Bacillus pumilus fermentation product, dried Trichoderma longibrachiatum fermentation extract, and dried Bacillus subtillis fermentation extract. HIVE ALIVE includes thymol, lemon grass and a Macro algae extract.

Bee products are also available for treatment of viral pathogens. These include HONEY “B” HEALTHY, which is made from lemon grass and spearmint oils, this product claims to destroy the protein capsules of the virus. Similarly, PRO HEALTH (from Mann Lakes) claims to have antiviral efficacy. It contains lemon grass and spearmint oils, but also adds thymol oils.

Varroa is a genus of parasitic mites associated with honey bees. Varroa mites are recognized as one of the biggest pests to honeybees worldwide, and may be the single largest contributing factor in the modern-day decline of honeybees, due mainly to their tendency to transmit viral diseases to larval or pupating bees, potentially resulting in colony collapse. Mite populations are typically higher in Autumn. Any of the compositions include one or more agents for treating or preventing Varroa, which may include another insecticide or non-insecticide. An example of an additional active agent is an acaricidal compound, i.e., any known agent which is effective against mites, particularly the Varroa mite, Varroa destructor and related species. Preferably the active agent has low or no toxicity against honeybees. Acaricidal compounds include semiochemicals (e.g. pheromones) used in controlling mite infestations. In one embodiment the acaricidal compound is selected from the group consisting of cis-8-dodecenyl acetate, 1-dodecanol, n-hexadecyl acetate, n-octadecyl acetate and methyl palmitate. In another embodiment, the acaricidal compound is a compound or mixture of compounds as disclosed in WO97/47193, e.g. an essential oil or an organic acid. Examples of essential oils are monoterpenes, such as menthol, geraniol, thymol, myrcene, citral, limonene, carene, camphor, eugenol, or cineol (eucalyptol); and natural oils such as lemon oil, eucalyptus oil, or neem oil. Examples of organic acids include acids such as formic acid, acetic acid or oxalic acid. In another embodiment the acaricidal compound is a pyrethroid, or an amnidine or related compound, such as flumethrin, fluvalinate, acrinathrin, amitraz, cymiazole hydrochloride, bromopropylate or fenpyroximate.

### III. Devices

In some embodiments, the anthranilic diamide insecticide such as chlorantraniliprole or flubendiamide or a composition formed therefrom including any of the compositions discussed in more detail above, is delivered to the bee hive or colony in a device. Thus, the devices and products can be formed or formulated to include insecticide and optionally any one or more other components or agents (e.g., nutritional or therapeutic compounds/compositions) discussed in more detail elsewhere herein.

An exemplary device is a strip, e.g., a polymer strip including the anthranilic diamide insecticide such as chlorantraniliprole or flubendiamide therein or thereon. See, e.g., U.S. Published Application No. 2012/0263772 which is specifically incorporated by reference herein in its entirety.

In some embodiments, the device is designed to be eaten by bees and/or pests, or disintegrate, dissolve, decompose, be disassembled by bees and/or pests, or otherwise degrade over time, so that at the end of the recommended lifetime the device (e.g., a strip) is no longer in its original form. By use of the term “break down”, “breaks down”, or variations herein, what is intended is to cover all methods of the strip changing form, either by disintegrating, dissolving, decomposing, being eaten by bees, being disassembled by bees, or otherwise degrading. In some embodiments, the device, at the end of the recommended lifetime, has broken down and is less than 50% of its original form, and preferably is less than 25% of its original form. In preferred embodiments, the device, or at least the portion of, or all of, the body having the insecticide therein or thereon, ceases to exist.

The insecticide and/or additional components such as nutritional and therapeutic substances can be present on or in a carrier, which is typically an inert carrier. The carrier used can be selected based on the mode of device-disappearance desired, but is generally a polymeric or starch or sugar based material. Beeswax is also an acceptable carrier. Various specific examples are provided below.

In some embodiments, to make a device such as a strip, the insecticide and optionally additional components can be dispersed throughout or dissolved in the substantially inert carrier or carrier matrix. The carrier matrix is then molded or otherwise shaped into the desired form, such as a strip. Molding may be done, for example, by casting or by extrusion. Alternately, the insecticide is applied, for example by immersion or spraying, to the carrier already formed into the desired shape and size. It is from the carrier that the insecticide is gradually released in the environment.

Non-limiting examples of suitable carriers that can be used include various gels, waxes (including paraffin wax and beeswax), gelatins, starches (for example, corn based) natural resins, rubbers, elastomers, synthetic and natural polymers, and the like. The carrier is preferably sufficiently strong and rigid to maintain the shape of the device during installation in a bee hive.

In some embodiments, the anthranilic diamide insecticide such as chlorantraniliprole or flubendiamide and optionally additional components such as nutritional and therapeutic substances are released from the device in a controlled manner. The insecticide and optional additional components may be present throughout or on the carrier matrix itself, which provides controlled release of the components, typically by diffusion. Additives may be included in the carrier matrix; additives that provide controlled release of the insecticide and optional additional components. Examples of adjuvant materials that provide controlled release of an active ingredient include porous particulates or substrates such as silica, perlite, talc, clay, pyrophyllite, diatomaceous earth, gelatin and gels, polymers (e.g., polyurea, polyurethane, polyamide, polyester, etc.), polymeric particles, or cellulose. At the end of the release of the insecticide and optional additional components, a body of device composed of the carrier may disintegrate, dissolve, decompose, be eaten by bees, disassembled by bees, or otherwise degrade.

In some embodiments, the device includes a transport limiting or diffusion limiting layer, such as a membrane, over the surface of the carrier and the insecticide to help control the flux of the insecticide. Various types of transport or diffusion limiting membranes are known.

In some embodiments, the release of the insecticide and optional additional components occurs as it is exposed, due to the carrier breaking down, either by disintegrating, dissolving, decomposing, being eaten or disassembled by bees or pests, or otherwise degrading. That is, new insecticide is exposed, and optionally released, as the body of the device breaks down and disappears. In some embodiments, no matter how released, that the insecticide is at a constant level. It is understood that various factors will affect the rate of active ingredient dispersal and strip disappearance, such as carrier material, density of carrier, concentration of active ingredient, desirability of carrier or strip (for strips that are eaten by the bees or pests), humidity and/or temperature of environment, and the like. Preferably, each of these is taken into consideration in designing the device.

Some carrier materials degrade or biodegrade, such as upon exposure to moisture, leaving little or no residue behind. Other carrier materials, such as sugar-based matrices, are eaten by the bees, leaving behind little or no residue. Yet other carrier materials, such as wax, are disassembled by the bees and moved to a different location. Beeswax may be disassembled and used as material for comb, whereas paraffin wax may be carried out of the hive. A combination of the degradation techniques (e.g., dissolving, chewing, eating, etc.) may occur.

The device can be composed of one or more materials, in order to provide a device such as a strip that dissolves or degrades, is eaten, or a combination. For example, the device can be made from a combination of sugar and gelatin; the bees would eat the sugar portion of the device, and their saliva would dissolve the gelatin portion. The device can be colored, scented, flavored, or otherwise designed to be more appealing to the bees.

In some embodiments, no matter whether dissolved, degraded, decomposed, eaten, carried away, or otherwise destroyed, the body of the device breaks down and ceases to exist at the end of the desired life time, e.g., 28 days or 45-60 days, etc.

Some devices include a base layer and an active layer, wherein the active layer includes an effective amount of an anthranilic diamide insecticide such as chlorantraniliprole or flubendiamide. By providing the insecticide in a separate layer, the amount of insecticide can be reduced considerably compared to, for example, polymer strips where the active agent is impregnated into the polymer.

In some embodiments, the composition includes a coating layer overlaying the active layer. The coating layer typically functions to provide a protective surface which reduces abrasion of the active layer, for instance during manufacture and/or transit of the product. This prevents loss of active ingredient before introduction of the composition into a bee colony, and also reduces the rate of egress of the insecticide and optional additional components when in use in the colony. However, the coating layer is preferably formed such that the coating layer can be slowly abraded whilst in use, thereby controlling release of the insecticide and optional additional components into the hive. In specific embodiments, the coating layer may be formed from a material such as cellulose, silica, polyethyl glycol or a wax. Typically, this coating layer does not include an active agent (e.g. an anthranilic diamide insecticide such as chlorantraniliprole or flubendiamide).

Thus, the devices can be laminated products, i.e., they have two or more distinct layers, each of the layers being formed from the same or different basic materials. Typically, the layers formed from different materials as determined by their differing functions. In some embodiments each layer may be formed from the same basic material (e.g. cellulose), although the active layer is typically distinct in that it includes the insecticide. Preferably the compositions are in the form of a strip, band or plate, or any other flat laminated structure.

Typically, the base layer functions to provide support to the active layer. Thus, in some embodiments the base layer is formed from a rigid material, such that the base layer provides support to the active layer and optionally also the coating layer. For example, the base layer may include essentially of cellulose, plastic (e.g. polyester) or metal (e.g. aluminum). Preferably the base layer does not include the anthranilic diamide insecticide such as chlorantraniliprole or flubendiamide, i.e., the base layer substantially lacks the insecticide. This avoids the need for excess insecticide to be used in the manufacture of the product.

The active layer typically includes the anthranilic diamide insecticide such as chlorantraniliprole or flubendiamide, and optionally additional agents, and is typically disposed on the surface of the base layer. In some embodiments, the active layer is formed from an inert material, such that an anthranilic diamide insecticide compound can be applied to the active layer in a solvent. In some embodiments, the active layer includes cellulose, silica, polyethyl glycol or a wax. In some embodiments, the active layer include an additional nutritional or therapeutic material, such as an additional pesticide.

In some embodiments, the disclosed compositions and/or devices provide slow or controlled release of the active agent. Thus, the concentration of the composition in the environment of the bee colony can be kept at an efficacious level over a period of time, e.g., 0.5, 1, 2, 3, 4, 5, 6, 7, 8, 9, 10, 11, 12, 12, 14, 15, or more days or months.

In some embodiments, the insecticide is incorporated into the active layer by absorption of a solution containing the anthranilic diamide insecticide such as chlorantraniliprole or flubendiamide into the active layer. For instance, the insecticide and optionally other agents may first be dissolved in an appropriate solvent (e.g. an organic solvent or water) and then the solution formed is applied to the active layer. In some embodiments, the active layer is dipped or bathed in the solution to allow the solution to be absorbed. The solvent may optionally be removed, for instance in the case of a volatile solvent by evaporation or drying.

The anthranilic diamide insecticide such as chlorantraniliprole or flubendiamide may be incorporated into the active layer before or after the active layer is applied to the base layer. However, if the base layer is absorbent it is possible to incorporate the active agent first (e.g. by dipping or bathing as mentioned above) before contacting with the base layer. This avoids the uptake of the active agent by the base layer. In an alternative embodiment where the base layer is non-absorbent, the base layer may first be applied to the active layer and then the active agent incorporated by application in a solution.

The active layer may be applied to the base layer by any suitable technique. In one example, the active layer is applied to the base layer by rolling.

A coating layer, if needed, may be applied onto the active layer by any suitable technique. In one embodiment the coating layer is applied by spraying, e.g., the coating layer material is provided in a liquid form (e.g. in a solution with an appropriate solvent), the liquid is sprayed onto the active layer and then allowed to dry.

See also U.S. Published Application Nos. 2014/0287013 and 2021/0052685, which are specifically incorporated by reference herein in their entireties.

### IV. Commercial Products

In some embodiments, the source of carbohydrates, proteins, lipids, vitamins, minerals, or water can be, or can be derived from, a commercially available feed such as AP23®, BEE-PRO®, FEEDBEE, MEGABEE, ULTRA BEE, HIVE ALIVE, SUPERDFM®-HONEYBEE™, or others mentioned herein or elsewhere. Therapeutic products include, for example, Para-Moth, a dry crystal used to control wax moths in stored supers; Apivar, an amitraz-based apiary product for treating varroa mites; ApiLife Var, a natural alternative against varroa mites based on thymol, eucalyptus oil, L-menthol and camphor; Api-bioxal, an oxalic-based Varroa treatment specifically approved for honey bees; Apiguard®, a natural treatment (slow release gel of thymol) to control varroa mite populations; or Checkmite+ are plastic strips the synthetic pesticide coumaphos for varroa control. Exemplary devices that can be used alone or in further combination with the existing active agents thereof to deliver the disclosed composition include, but are not limited to, Aluen CAP, which is formed of four strips made of cellulose impregnated with a solution based on oxalic acid as an active principle. Thus, in some embodiments, an effective amount of an anthranilic diamide insecticide such as chlorantraniliprole or flubendiamide is added directly to commercial product and/or device such as, but not limited to, the foregoing. Thus, the anthranilic diamide insecticide such as chlorantraniliprole or flubendiamide can be administered to the bee hive through the commercial product or device. In some embodiments, the commercial product is administered according to the manufacturer's instructions.

### V. Methods of Use

It has been discovered that certain anthranilic diamide insecticides, particularly chlorantraniliprole and flubendiamide, can be formulated to kill undesirable pests such the small hive beetle (Aethina tumida) and wax moths (Achroia grisella) without killing honey bees. Thus, methods of reducing or preventing small hive beetle and/or wax moth pest infestation of honey bee hives are also provided. The disclosed compositions and formulations can be administered by any suitable means. A preferred method of administration is placement of an insecticide-spiked food or nutritional source in or around the honey bee hive. The spiked or nutritional source serves as a lethal attractant when ingested by the pest. The formulations are non-lethal, preferably non-harmful and/or non-toxic to bees, who may also eat the spiked food and be nourished. Thus, the compositions and methods can both directly and indirectly increase bee health and safety.

Typically, the methods provide for administration of the disclosed compositions and formulations via ingestion through the normal feeds and feeding schedule of the bees and pest. Thus, in preferred embodiments, the insecticide compositions and formulations are provided as food, feed additive or supplement, or nutraceutical. The compositions and formulations can be placed in an area where bees are located or within feeding vicinity of bees, such as in or adjacent to a bee hive or bee cage, or also inside the hive, e.g., as a patty or as a liquid or delivery device. By “patty” is meant bee food or supplement formed into a soft pliable dough-like consistency that is pressed into a thin patty. Patties are typically provided to honey bee colonies to support the protein and nutritional need of the colony, and may include one or more of protein, sugar syrup, and/or other bee dietary needs. In some embodiments, delivery of the formulation is assisted by a device such as a strip, including, but not limited to, those discussed above.

By way of example, mechanisms for providing the disclosed compositions and formulations to bees are summarized below. However, these are not intended to be limiting. One of skill in the art can readily determine appropriate methods for administration of the compositions to honey bees of interest. Appropriates amounts and timing of feeding are known to those skilled in the art and are readily ascertainable.

The compositions and formulations may be fed to pests and optionally honey bees or a colony of honey bees in a variety of ways. For example, the compositions may be formulated as a liquid and fed within a hive or colony in a horizontal feeder in place of a comb. Alternatively, or in addition, the compositions may be placed in a vertical feeder, which is in turn placed on top of a comb within the hive.

The compositions may be formulated as a liquid, a patty, or a biscuit. In certain embodiments, the composition is provided adjacent to a comb in the hive, e.g., on top of the comb. The compositions can be provided on a mesh through which the bees can pass. In certain embodiments, the compositions formulated as a liquid is provided in an inverted jar inserted into a hole in the roof of a hive. In certain embodiments, the compositions may be provided in an area surrounding a hive (e.g., within an apiary). In such embodiments, the composition may be formulated as a liquid or a powder.

In some embodiments, the composition may for example be provided via a frame feeder, or may be poured or sprayed.

In any of the foregoing, the compositions and formulations can be provided before or after detection of infestation of small hive beetles or wax moths. This can be over any period of time, for example, minutes, hours, days, or weeks before or after infestation.

The compositions and formulations can provided ad lib, i.e., the pest and/or bees can feed freely as desired, and/or via a time (e.g., slow) release device. For example, the compositions containing an effective amount of insecticide can be formulated as a liquid (e.g., sugar syrup) that is placed in a bag or jar or strip in, on, or near the hive. The pests and bees can access and ingest the composition as desired over the period of time.

The pests may ingest an effective amount of an insecticide composition on a single, repeated, or regular basis. For example, the pest may ingest an effective amount of an insecticide composition one, two, three, or more times weekly, every other day, every day, or more than once every day (e.g., once, twice, three, or more times every day) during the performance of the disclosed methods or uses.

The amount of a composition administered to the pest is typically enough to prevent, reduce, decrease, or inhibit one or more adverse effects associated with pest infestation. For example, in some embodiments, the amount of anthranilic diamide insecticide, such as chlorantraniliprole and flubendiamide, in the compositions is effective to prevent, reduce, decrease, or inhibit the invasion, establishment, and/or proliferation/expansion of pests in the honey bees' hive. In preferred embodiments, the compositions and methods reduce or prevent the pests from damaging the habitat or food stores, for example, damage to the hive generally, or a comb(s), stored honey, and/or pollen specifically alone or in combination with reducing pest-induced bee mortality. If a beetle infestation is sufficiently heavy, they may cause bees to abandon their hive. Thus, preferable, the compositions and methods additionally or alternatively prevent colony abandonment and/or colony collapse disorder, a phenomenon that occurs when the majority of worker bees in a honey bee colony disappear, leaving behind a queen and a few nurse bees to care for the remaining immature bees.

The compositions and methods are typically also carried out in a means that limits or prevents direct damage or injury to the honey bees or their hive. Thus, the combination of the amount of the composition and its method of administration are typically balanced to provide maximum impact against the pest(s) with minimal impact against the honey bees.

Effective amounts can be expressed as total mass (e.g., mg), an amount per unit body weight of the recipient (e.g., mg/kg), as body surface-area based dosing (e.g., mg/m²) and the like. Preferable, the insecticide is administered in a dose lower than the contact, or more preferably the oral, LD50 for honey bees, and more preferably in dose that is lower than causes significant (e.g., statistically significant) bee mortality (e.g., as discussed above). In some embodiments, the disclosed compositions contain an anthranilic diamide insecticide, such as chlorantraniliprole or flubendiamide, in the concentration range of about 0.01 μg/gram to 100 μg/gram solid feed, or any subrange or specific dosage therebetween. In some embodiments, the disclosed compositions contain an anthranilic diamide insecticide, such as chlorantraniliprole or flubendiamide, of about 0.1 μg/ml to 100 μg/ml liquid feed, or any subrange or specific dosage therebetween. In some embodiments, the dosage is a specific dose between the foregoing ranges and subranges, inclusive of the end points. The dosage of tested compounds are also discussed in the Examples below, and such dosages can be utilized in the disclosed compositions and methods. A preferred dosage is 10 μg/gram of solid feed, though experimental results indicate that at least doses ranging from 0.5×-20× of this concentration are both safe and effective.

The actual effective amounts of an active agent (e.g., an anthranilic diamide insecticide such as chlorantraniliprole and flubendiamide) can vary according to factors including the specific compound, the particular composition formulated, the mode of administration, and/or the condition of the subject (e.g., pest and/or honey bees) being administered.

### VI. Methods of Making

Methods for the production of the disclosed compositions including food, feed additive or supplements, and nutraceuticals are provided. Exemplary feed include feed for honeybees (e.g., sugar syrup, patties). The methods can include the steps of incorporating an anthranilic diamide insecticide such as chlorantraniliprole and flubendiamide into the feed product or feed supplement product during the preparation of the feed or supplement. An animal feed or feed supplement for use in the methods described herein may include an effective amount of an anthranilic diamide insecticide such as chlorantraniliprole and flubendiamide, as well as proteins, lipids, carbohydrates, minerals, water, other nutrients or ingredients, or combinations thereof.

The anthranilic diamide insecticide such as chlorantraniliprole and flubendiamide may be incorporated into the feed product at any stage during the production process including before one or more heating or cooling steps and/or mixing steps.

The following processes may be used alone or in combination, as needed to provide the disclosed compositions and formulations: stirring, mixing, size reduction, cooling, and heating. Ingredients can be mixed, cooled, and heated to dissolve the anthranilic diamide and other particles to achieve appropriate homogenous dispersal throughout the prepared feed or to enable storage and transportation of products. Dry ingredients can be mixed and blended in a high power mixer/blender to achieve complete mixing and size reduction of the particles. Liquid ingredients may be added to the dry ingredients in the same manner. The mixing is carried out sufficient to render the components into a well-dispersed form that is available in a substantially homogeneous manner. If desired, size reduction is carried out sufficient to render the components to be of a size and form so as to remain suspended in the final formulation and be of size acceptable to the mouthparts of an insect, e.g., a bee. In cases where the source ingredients are not greater than about 35 microns, size reduction may not be required. Heating can serve to increase the digestibility and absorption potential for components such as proteins and to destroy microbes, especially those in vegetative phases of their life cycle. Preferably heating is carried out sufficient to accomplish the foregoing but insufficient to cause excessive destruction or breakdown of the nutrients or insecticide. Both heating and cooling can serve to increase the solubility of ingredients in their carrier solvents. Cooling can also serve to preserve ingredients. Mixing, cooling, and heating parameters for a particular set of circumstances can be readily determined by routine experimentation. In some embodiments, dry and/or solid formulations are mixed with water or liquid formulations to provide the final feed product.

In some embodiments, the composition is first prepared in a concentrated liquid formulation and later diluted to a final liquid or a dry/solid formulation formed by mixing a concentrated liquid formulation with additional ingredients. For example, in some embodiments a concentrated liquid form includes insecticide dissolved in a solvent such as methanol and optionally further including a stabilizing solution such as glycerol. Such a formulation can be in a concentrated form, e.g., 2×-20× or more times insecticide as in the final product. Concentrated formulations can be used as for, e.g., transportation, storage, and/or stock solutions to later prepare further liquid or dry/solid formulations for use in a hive.

For example, an insecticide such as chlorantraniliprole can be dissolved in a solvent such as methanol at a ratio of, e.g., 1 mg insecticide to 1 ml solvent via agitation/stirring. Insecticide-solvent solution can be cooled to e.g., −20° C. and then suspended/mixed into stabilizing solution such as glycerol also cooled to e.g., −20° C. and stored e.g., between 4° C. and −20° C. to create a shelf-stable product (i.e., stock solution). Product can then be mixed into lethal attractant/supplementary feed e.g., at a rate of 50 ml formulated product per 1 kg feed or attractant via either mechanical or hand mixing at ambient temperature. Treated attractant/feed mixture is then ready for deployment in a honey bee hive. For example, in the experiments below, 200 ml of 80% glycerol/20% methanol stock solution was added to 4 kg of protein feed (40 ml glycerol and 10 ml methanol per 1 kg protein feed). It will be appreciated that these ingredients, ratios, amounts, temperatures, etc., are exemplary and non-limiting. Ingredients can be substituted as described elsewhere herein, and ratios and amounts and methodology can be altered to achieve the desired results, e.g., to dissolve or suspend the insecticide in a stock solution and/or as an effective amount in a final product to be used to treat pests as described herein.

Preferred concentrations for the active ingredient may vary in accordance with the ability of the pre-formulation to maintain the insecticide in solution, and where the pre-formulation can be mixed with large quantities of feed or lethal attractant but still maintain adequate dose delivery. Experimental results indicate doses ranging from at least 0.5×-20× the concentration as described above would be suitable.

The disclosed invention can be further understood through the following numbered paragraphs:

1. A composition suitable for administration to or ingestion by a honey bee including an effective amount of an anthranilic diamide insecticide to reduce or prevent a parasitic insect infestation of the honey bee's hive.

2. The composition of paragraph 1 further including a source of carbohydrates, proteins, lipids, vitamins, minerals, water, or a combination thereof.

3. The composition of paragraphs 1 or 2, wherein the source is natural or artificial nectar, honey, sugar, sugar syrup, pollen or pollen substitute, soy flour, soy meal, gluten, skim milk, yeast, pollard, oil, or combinations thereof.

4. The composition of paragraphs 2 or 3, wherein the source is selected from the group including AP23®, BEE-PRO®, FEEDBEE, MEGABEE, ULTRA BEE, HIVE ALIVE, or SUPERDFM®-HONEYBEE™.

5. The composition of any one of paragraphs 1-4, wherein the anthranilic diamide is chlorantraniliprole or flubendiamide.

6. The composition of paragraph 5, wherein the anthranilic diamide is chlorantraniliprole.

7. The composition of any one of paragraphs 1-6, wherein the composition is not lethal to the bee.

8. The composition of any one of paragraphs 1-7, wherein the amount of the anthranilic diamide is below the contact and/or oral LD50 for the bee, optionally wherein the amount of the anthranilic diamide does not significantly raise the mortality of a colony to which the bee belongs.

9. The composition of any one of paragraphs 1-8, wherein the amount of the anthranilic diamide is about 0.01 μg/bee to 100 μg/bee, or about 0.1 μg/gram to 100 μg/gram, or any subrange or specific dosage therebetween.

10. The composition of any one of paragraphs 1-9, wherein the composition is a liquid.

11. The composition of any one of paragraphs 1-9, wherein the composition is a solid.

12. The composition of paragraph 11, wherein the solid is a powder, patty, or candy.

13. The composition of any one of paragraphs 1-12 further including a therapeutic active agent.

14. The composition of paragraph 13, wherein the therapeutic active agent is a pesticide.

15. The composition of paragraphs 13 or 14, where the therapeutic active agent is for treatment of varroa.

16. The composition of any one of paragraphs 1-15, wherein the bee is a Apis andreniformis (the black dwarf honey bee); Apis cerana (the eastern honey bee); Apis dorsata (the giant honey bee); Apis florea (the red dwarf honey bee); Apis koschevnikovi (Koschevnikov's honey bee); Apis laboriosa (the Himalayan giant honey bee); Apis mellifera (the western honey bee); and Apis nigrocincia (the Philippine honey bee).

17. The composition of any one of paragraphs 1-16, wherein the parasitic pest is small hive beetle (Aethina tumida) or wax moth (Achroia grisella).

18. The composition of any one of paragraphs 1-17, wherein the anthranilic diamide and/or the effective amount thereof is non-toxic to the bee.

19. The composition of any one of paragraphs 1-18, wherein the composition is a nutritional supplement for the bee.

20. The composition of any one of paragraphs 1-19, wherein the composition attracts the pest.

21. A device including the composition of any one of paragraphs 1-20.

22. The device of paragraph 21, including one or more strips.

23. The device of paragraphs 21 or 22, including one, two, or more than two layers, wherein at least one of the layers does not include the anthranilic diamide.

24. The device of any one of paragraphs 21-23 including a carrier optionally selected from a polymeric or starch or sugar-based material.

25. The device of paragraph 24, wherein the anthranilic diamide is released as it is exposed, optionally due to the carrier breaking down, optionally by disintegrating, dissolving, decomposing, being eaten or disassembled by bees or pests, or otherwise degrading.

26. A method of treating or preventing parasitic pest infestation of a bee hive including placing the composition of any one of paragraphs 1-20 or device of any one of paragraphs 21-25 in, on, or adjacent to the bee hive.

27. The method of paragraph 26, wherein the bee hive includes a colony.

28. The method of paragraph 26, wherein the bee hive is natural or artificial.

29. The method of any one of paragraphs 26-28 including replacing the composition or device every 0.5, 1, 2, 3, 4, 5, 6, 7, 8, 9, 10, 11, 12, 12, 14, 15, or more days or months.

30. The composition, device, or method of any one of paragraphs 1-29, wherein the composition includes a protein or pollen patty including chlorantraniliprole, the pest is small hive beetle, and bee is Apis mellifera or Apis cerana.

31. A liquid stock composition including 0.2 μg/ml to 2 mg/ml of an anthranilic diamide insecticide.

32. The liquid stock composition of paragraph 31 including solvent and optionally a stabilizing solution.

33. The liquid stock composition of paragraph 32, wherein the solvent is an organic solvent optionally selected from methanol, acetone, ethanol, and ethyl acetate.

34. The liquid stock composition of any one of paragraphs 32 or 33, including the stabilizing solution, optionally wherein the stabilizing solution is glycerol.

35. The liquid stock composition of any one of paragraphs 31-34, including a 1:1 ratio of insecticide:liquid.

36. The liquid stock composition of any one of paragraphs 31-35, wherein the insecticide is chlorantraniliprole.

37. A method of making a composition suitable for administration to or ingestion by a honey bee including diluting the liquid stock of insecticide in a source of carbohydrates, proteins, lipids, vitamins, minerals, water, or a combination thereof.

38. The method of paragraphs 37, wherein the liquid stock of insecticide is the composition of any one of paragraphs 31-36.

39. The method of paragraphs 37 or 38, wherein the liquid stock is diluted by 2×-20×.

40. The method of any one of paragraphs 37-39, wherein the source includes natural or artificial nectar, honey, sugar, sugar syrup, pollen or pollen substitute, soy flour, soy meal, gluten, skim milk, yeast, pollard, oil, or combinations thereof.

41. The method of any one of paragraphs 37-40, wherein the source is selected from the group consisting of AP23®, BEE-PRO®, FEEDBEE, MEGABEE, ULTRA BEE, HIVE ALIVE, or SUPERDFM®-HONEYBEE™.

42. The method of any one of paragraphs 37-41, wherein the source is a solid source and the final concentration range of the insecticide is 0.01 μg/gram to 100 μg/gram insecticide/solid source or any subrange or specific dosage therebetween.

43. The method of any one of paragraphs 37-41, wherein the source is a liquid source and the final concentration range of the insecticide is 0.1 μg/ml to 100 μg/ml insecticide/liquid source, or any subrange or specific dosage therebetween.

### EXAMPLES

### Example 1: Oral Ingestion of Chlorantraniliprole is Lethal to Small Hive Beetles

### Materials and Methods

### Preliminary Assay

Preliminary tests were undertaken on small hive beetle larvae collected from infested frames of an absconded colony. Wandering stage larvae were harvested from frames and incubated at 30 C for 10 days following collection. After incubation, larvae were separated into 24 cohorts of 20 individuals (n=480) and provided with 1 mL of honey solution (2:3 honey/water) and were given 3 hours to acclimate. Concurrently, chlorantraniliprole sourced from commercial grade lawn pellets (Scott's GrubEx) was agitated in water for 90 minutes at 30 C, resulting in a solution with ˜0.08% chlorantraniliprole (50 g GrubEx in 450 mL water). After the acclimation period, cohorts were split in half, with 10 individuals of each cohort placed in a treatment plate and the remaining 10 individuals placed into a control plate. Via spray bottle, treatment plates were doused with 1.5 mL Chlorantraniliprole test solution, while control plates were doused with 1.5 mL water. All plates were then immediately placed back into the 30 C incubator. All water used was tap water from the Athens, Georgia water supply. After two days, all plates were removed from the incubator and mortality rates were observed.

### SHB Adult Exposure Toxicity Assay

Testing on chlorantraniliprole contact effectiveness was also conducted on small hive beetle adults. Each plate in which small hive beetles were placed contained an approximately 1 in×1 in square of absorbent shop towel located in the middle of the pot, soaked with solution via pipette. Tests included a methanol-negative (1:1 sugar to water/w) control group with 6 plates of 8 individuals, a methanol-positive (1:1 sugar to water/w solution with methanol then added in to be 1/6 of volume) control group with 7 plates of 8 individuals, a 5 μg treatment group (same as methanol-positive control with 5 μg a.i. added) with 7 plates of 8 individuals, and a 10 μg group (same as methanol-positive control with 10 μg a.i. added) with 7 plates of 8 individuals. Numbers of live beetles were tallied at the end of the test period.

### SHB Adult Feed Toxicity and Reproduction Assay

In-feed testing with adult small hive beetles was done with small hive beetle adults taken from colonies in the field and individuals reared in-lab. Adults from the field and in-lab were given three days to acclimate together in a large container with feed (2 parts pollen supplement; 1 part pollen; 1/2 part honey) in an incubator at 30 C. Simultaneously, 50 mg of Chlorantraniliprole was suspended in 50 mL (1.25 g/mL) glycerol, which was then mixed into 100 g feed, resulting in a concentration of 0.3 mg Chlorantraniliprole per 1 gram feed. A concentration of 100 μg of active ingredient per 1 gram feed was then achieved via dilution with feed and glycerol solution. Using serial dilution, feeds with varying concentrations of active ingredient were mixed, producing feeds with 100 μg, 10 μg, 1 μg, 0 μg (control) active ingredient per 1 g feed. Following the acclimation period, approximately 10 adult small hive beetles (some pots contained more than 10 individuals, but no more than 12) were randomly assigned to 32 pots, with 8 pots randomly assigned to each treatment (100 μg, 10 μg, 1 μg, 0 μg Chlorantraniliprole). Mortality and reproduction were then monitored at 4, 6, 18 and 34 days.

### Results

Experiments were designed to investigate the toxicity of chlorantraniliprole to honey bees and small hive beetles (SHB), and identify an appropriate dosage range for testing the ability of the insecticide to reduce beetle infestation without harming the bees. In a preliminary assay, larvae doused with the commercial lawn pellet solution died at higher rates than control plates doused with water, indicating that chlorantraniliprole may be a useful pesticide for targeting small hive beetle parasites. Research-grade chlorantraniliprole was then acquired and used in further experiments.

Activity against adult SHB was next tested in an exposure toxicity assay. Results show no evidence of elevated mortality of small hive beetles via this contact exposure route—all adult small hive beetles survived the experiment. While direct dousing of adult beetles may be lethal, their adult forms are capable of avoiding environmental chlorantraniliprole.

Next, ingestion of the pesticide was tested. At a dosage of 100 μg/g chlorantraniliprole, all adult small hive beetles were dead within 6 days of exposure. Elevated mortality of the adult beetles was also observed for the 10 μg/g chlorantraniliprole treatment. No evidence of any larvael SHB were observed at these concentrations. In the 1 μg/g chlorantraniliprole, few larvae were observed but subsequently died while still in their first or second instars, with no larvae growing beyond their 3^{rd} instar. At the 0 μg/g chlorantraniliprole treatment, SHB readily reproduced, leading to tens or hundreds of SHB larvae which rapidly grew to their final instar (larval phase). This demonstrates that the chlorantraniliprole is effective when paired with a lethal attractant (food) via comparison to the exposure tests above. It also demonstrates the principle of preventing SHB reproduction in honey bee supplemental food.

### Example 2: Chlorantraniliprole-Spiked Protein Patties Eliminate Small Hive Beetle Infestation

### Materials and Methods

### Field Assay

Pollen supplement was weighed out into two masses, each approximately 4 kg. To create the control pollen supplement patties, 200 ml of 80% glycerol, 20% methanol by volume solution was added to the pollen supplement mass. To create treated patties, 200 ml of 80% glycerol, 20% methanol 1 mg/ml chlorantraniliprole solution by volume was added to the other 4 kg pollen supplement mass. Control and treatment masses were both separated into 10 patties of approximately 375 g (+/−0.8 g). Two sites were selected for application, with 10 patties (5 control and 5 treatment) being applied to hives at site 1, and 10 patties (5 control and 5 treatment) at site 2. Applied patties were place on a paper towel on top of frames on the top box in hives, and a frame spacer was placed between the top box and lid to give ample space for the patties. Following a period of 5 days during which control and treatment patties remained in hives, the remaining masses of patties were removed from hives. The surfaces of pollen supplement patties were observed post-collection for the presence of larvae, and their masses were weighed to observe the amount of pollen supplement consumed by honeybees. These half-patties were then placed into containers and put into an incubator at 30 C. After being allowed to incubate for 14 days, pollen supplement patties were then observed again at the surface level for visible presence of larvae.

### Results

Informed by the above experiments, the ‘formulated product’ was subsequently tested in the field. An experiment was designed to test the impact of chlorantraniliprole on bees and small hive beetle (SHB), when the formulation was placed in an active colony using a spiked protein patty. Treated and control protein patties were placed in colonies as standard by beekeepers for 5 days before retrieval. Bees consumed the chlorantraniliprole-treated protein at the same or higher rates than control/untreated. Treated patties remained free of SHB infestation, while 100% of untreated control patties (no chlorantraniliprole, but including the inert methanol and glycerol mixture) were infested in the five day field trial period.

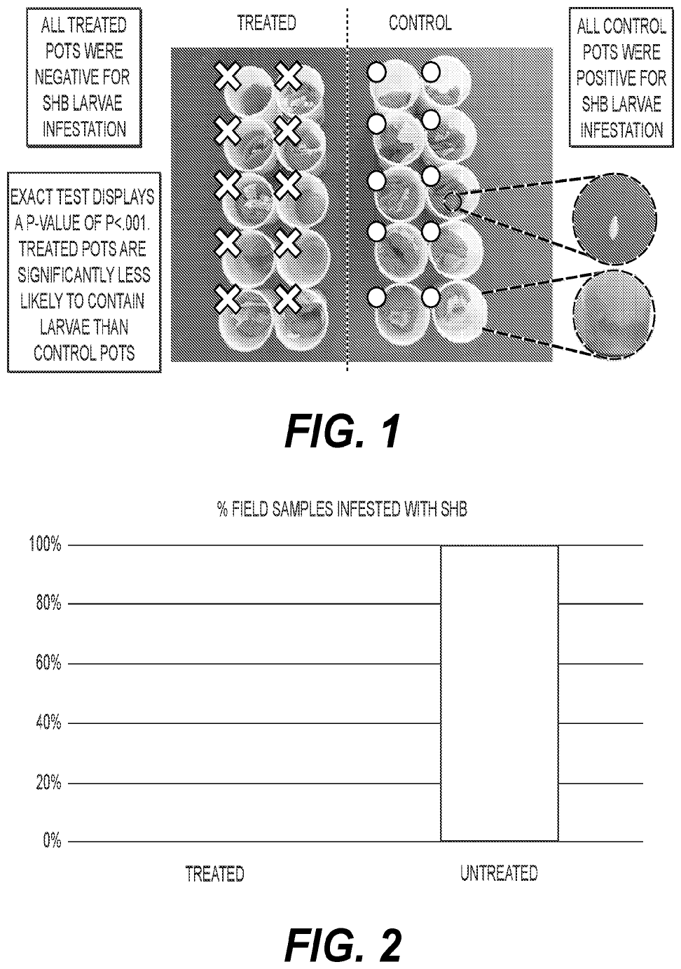

Upon retrieval, 9/10 control pots showed immediately visible infestation rates. Following two weeks of incubation to hatch eggs, product-treated supplementary food remained SHB-infestation free, while control/untreated feed showed very extensive infestation with many hundreds of parasitic SHB larvae. The images show SHB larvae positive pots (“O”) and SHB larvae negative pots (“X”). Pots treated with chlorantraniliprole are displayed on the left half of the graph, control pots on the right half. The experimental results from FIG. 1, are reproduced as a graph in FIG. 2, showing the infestation rates of protein substitute mixed with the formulated chlorantraniliprole according to trial instructions compared to untreated/control supplementary feed. Instructions achieve approximately 10 μg chlorantraniliprole per 1 g protein feed.

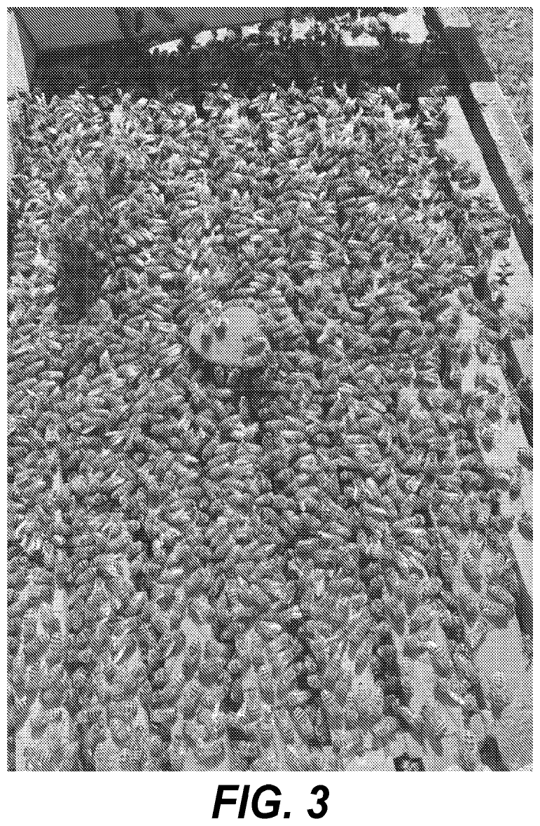

FIG. 3 is an image of a chlorantraniliprole-treated patty prior to recovering it after short placement in a honey bee colony. It was placed on top of wax paper to keep it ‘whole’. The image was taken during a colony inspection when the bee hive was open. The image shows that only a small amount of the original full-sized ‘patty’ remains.

These results demonstrated the in-field replication of the above laboratory findings and a proof of efficacy for feeding honey bee supplementary protein without inciting elevated parasitism.

### Example 3: Chlorantraniliprole is Non-Toxic to Honey Bees

### Materials and Methods

### Adult Honeybee Atoxicity Assays

In all instances, isocaloric sugar feed solutions were used (all honey bees were exposed to feed of equivalent sugar concentration). Both sets of experiments also tested the safety of methanol as a solvent for carrying the chlorantraniliprole. Mortality cages used approximately 20-50 bees per cage replicated across numerous colonies. Each cage was treated with one experimental dose of feed. Each colony donates a cage of bees to each dose in a full factorial experiment in line with tests used for EPA evaluation. Mortality was recorded at 24 hours and 48 hours.

Experimental set one included six different treatments: 10, 5, 2.5, 1.25, 0 μg/mL chlorantraniliprole with 30% methanol by volume, and 0 μg/mL chlorantraniliprole with no methanol.

Experimental set two used much higher concentrations of chlorantraniliprole and also included a positive control (dimethoate, a known bee-toxic insecticide). Treatments included chlorantraniliprole concentrations of: 0 (w/methanol), 0 (w/o methanol), 0 (positive dimethoate control), 5, 15, 65, 250 μg/mL.

### Results

Two sets of experiments were conducted to confirm the safety of chlorantraniliprole for honey bees. In both experiments, no significant increase in honey bee mortality in relation to the dose of chlorantraniliprole was observed.

Sublethal lethargy was observed in the honeybees at the very highest (250 μg/mL) chlorantraniliprole dose, however, notably this is 25× higher than the dose demonstrated to fully effective in the field. No evidence of any toxicity of the methanol solvent was observed. In experiment set two, all bees exposed to the positive control (dimethmoate) died, demonstrating the effectiveness of the assay protocol in showing when inseciticides are deadly to bees.

Furthermore, as part of the field tests of the formulated product discussed above, honey bees showed no avoidance of the chlorantraniliprole treated feed patties when places in the colony compared to untreated control patties. They showed some evidence of a preference for treated patties.

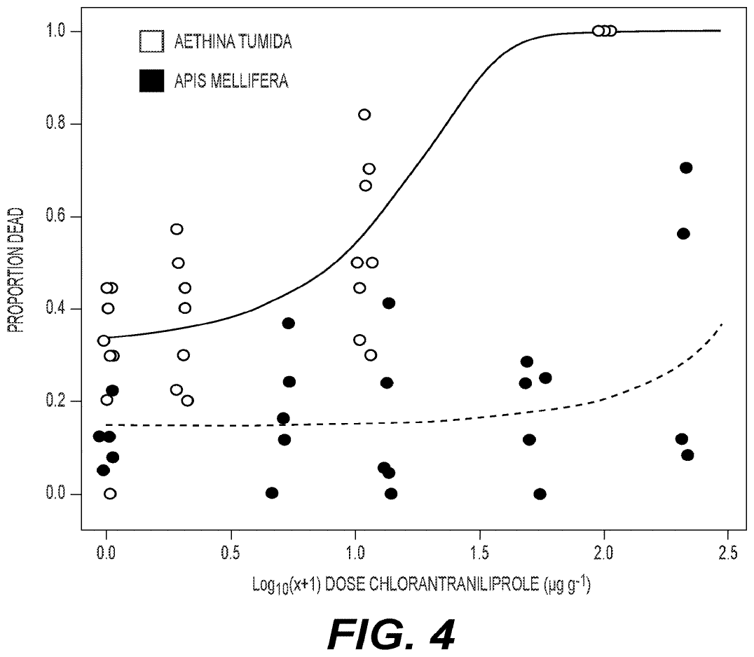

FIG. 4 is a mortality curve showing exemplary results: mortality of honeybees (lower line) and small hive beetles (upper line) at different dosages of chlorantraniliprole (μg/gram feed). EPA Data indicates oral toxicity (LD50) for bees exceeds 100 μg a.i. per bee, which agrees with other measures from the scientific literature (e.g. Dinter et al. 2009, 10th International Symposium of the ICP-Bee Protection Group). This is above the range at which the tested chlorantraniliprole formulation works. This data corroborates data from the literature, with no adult bee mortality at effective control concentrations (USDA-standard laboratory trials).

Collectively, the results of these experiments show that the antiparasitic agent chlorantraniliprole prevents small hive beetle infestation of supplementary protein feeds used in honey bee colonies and acts as a bee-safe lethal attractant for the parasitic beetles.

Unless defined otherwise, all technical and scientific terms used herein have the same meanings as commonly understood by one of skill in the art to which the disclosed invention belongs. Publications cited herein and the materials for which they are cited are specifically incorporated by reference.

Those skilled in the art will recognize, or be able to ascertain using no more than routine experimentation, many equivalents to the specific embodiments of the invention described herein. Such equivalents are intended to be encompassed by the following claims.

1.-43. (canceled)

44. A composition comprising:
chlorantraniliprole and
a source of carbohydrates, proteins, lipids, vitamins, minerals, water, or a combination thereof;
wherein the composition is a solid.

45. The composition of claim 44, wherein chlorantraniliprole concentration of the solid is below the contact and/or oral LD50 for a bee.

46. The composition of claim 44, wherein the composition comprises a chlorantraniliprole concentration toxic to small hive beetle (Aethina tumida).

47. The composition of claim 44, wherein the composition comprises a chlorantraniliprole concentration of about 0.1 μg/gram to 100 μg/gram of the solid.

48. The composition of claim 44, wherein the solid is a powder, patty, or candy.

49. The composition of claim 44, wherein the source is a source of proteins.

50. The composition of claim 44, wherein the source is natural or artificial nectar, honey, sugar, sugar syrup, pollen or pollen substitute, soy flour, soy meal, gluten, skim milk, yeast, pollard, oil, or combinations thereof.

51. The composition of claim 44, wherein the source is the pollen or pollen substitute.

52. The composition of claim 44, wherein the composition is a nutritional supplement for a bee.

53. The composition of claim 44, further comprising a therapeutic active agent.

54. The composition of claim 53, wherein the therapeutic agent is a pesticide.

55. The composition of claim 53, wherein the therapeutic active agent is a therapeutic agent for treatment of varroa.

56. A device comprising the composition of claim 44.

57. A method of treating or preventing small hive beetle (Aethina tumida) infestation of a bee hive, the method comprising:
placing a solid composition or device comprising chlorantraniliprole in, on, or adjacent to a bee hive.

58. The method of claim 57, further comprising replacing the composition or device every 0.5, 1, 2, 3, 4, 5, 6, 7, 8, 9, 10, 11, 12, 12, 14, 15, or more days or months.

59. The method of claim 57, wherein the bee hive is a hive for an Apis andreniformis (black dwarf honey bee); an Apis cerana (eastern honey bee); an Apis dorsata (giant honey bee); an Apis florea (red dwarf honey bee); an Apis koschevnikovi (Koschevnikov's honey bee); an Apis laboriosa (Himalayan giant honey bee); an Apis mellifera (western honey bee); or an Apis nigrocincta (Philippine honey bee).

60. The method of claim 57, wherein the bee hive is a hive for an Apis mellifera or an Apis cerana.

61. A liquid composition comprising:
chlorantraniliprole, and
an organic solvent;
wherein the liquid composition comprises 0.2 μg/ml to 2 mg/ml of the chlorantraniliprole.

62. The liquid composition of claim 61, wherein the organic solvent is selected from methanol, acetone, ethanol, and ethyl acetate.

63. The liquid composition of claim 61, comprising glycerol.
